(19) United States
(12) Patent Application Publication
(10) Pub. No.: US 2026/0181750 A1
(43) Pub. Date: Jun. 25, 2026

(54) COOKING APPARATUS AND METHOD FOR CONTROLLING THEREOF

(71) Applicant: SAMSUNG ELECTRONICS CO., LTD., Suwon-si (KR)

(72) Inventors: Geun KANG, Suwon-si (KR); Dongwook KIM, Suwon-si (KR); Jonghun HA, Suwon-si (KR)

(73) Assignee: SAMSUNG ELECTRONICS CO., LTD., Suwon-si (KR)

(21) Appl. No.: 19/544,191

(22) Filed: Feb. 19, 2026

Related U.S. Application Data
(63) Continuation of application No. PCT/KR2024/010833, filed on Jul. 25, 2024.

(30) Foreign Application Priority Data
Sep. 26, 2023 (KR) 10-2023-0129342
Mar. 21, 2024 (KR) 10-2024-0039100

(51) Int. Cl. H05B 6/12; H05B 6/06

(52) U.S. Cl. CPC H05B 6/1263; H05B 6/06

(57) ABSTRACT

Provided is a cooking apparatus including: a main body; a communicator inside the main body; a coil inside the main body, wherein the coil is configured to have a container placed above the coil; a fan inside the main body; memory storing at least one instruction; and at least one processor, wherein the at least one instruction, when executed by the at least one processor individually or collectively, causes the cooking apparatus to: based on execution of an operation mode, supply power to the coil, based on execution of a non-operation mode, block power from being supplied to the coil, based on execution of the non-operation mode, execute a standby mode, communicate with a home appliance using the communicator at a reference time interval while executing the standby mode, and cause the fan to rotate based on operation information received from the home appliance.

### CROSS-REFERENCE TO RELATED APPLICATIONS

This application is a by-pass continuation of International Application No. PCT/KR2024/010833, filed on July 25, 2024, which is based on and claims priority to Korean Patent Application No. 10-2023-0129342, filed in the Korean Intellectual Property Office on September 26, 2023, and Korean Patent Application No. 10-2024-0039100, filed in the Korean Intellectual Property Office on March 21, 2024, the disclosures of which are incorporated by reference herein in their entireties.

### BACKGROUND

### 1. Field

The present disclosure relates to a cooking apparatus and control method thereof for preventing damage to components.

### 2. Description of Related Art

In general, cooking apparatuses, which are apparatuses for cooking food by heating the food, are broadly divided into apparatus which generate heat for heating food by using electricity and apparatus which generate heat for heating food by burning gas. The cooking apparatuses are classified into gas ranges, ovens, and electric ranges.

Electric ranges include highlight electric ranges that directly heat heating elements by using electricity, induction heating electric ranges that generate heat in containers by magnetic fields formed in coils, hot plates that heat coil-shaped heating wires under cast iron or coated hot plates, and halogen electric ranges that heat cooking containers with far-infrared power from halogen lamps.

The cooking apparatuses may malfunction when the environments of the installation spaces change to high temperature and high humidity environments.

### SUMMARY

Provided is a cooking apparatus and control method thereof for communicating with at least one home appliance at a first time interval based on an operation mode, communicating with the at least one home appliance at a second time interval based on a non-operation mode, and performing cooling based on operation information received from the at least one home appliance while communicating with the at least one home appliance.

According to an aspect of the disclosure, a cooking apparatus includes: a main body; a communicator inside the main body; a coil inside the main body, wherein the coil is configured to have a container placed above the coil; a fan inside the main body; memory storing at least one instruction; and at least one processor, wherein the at least one instruction, when executed by the at least one processor individually or collectively, causes the cooking apparatus to: based on execution of an operation mode, supply power to the coil, based on execution of a non-operation mode, block power from being supplied to the coil, based on execution of the non-operation mode, execute a standby mode, communicate with a home appliance using the communicator at a reference time interval while executing the standby mode, and cause the fan to rotate based on operation information received from the home appliance.

The at least one instruction, when executed by the at least one processor individually or collectively, may further cause the cooking apparatus to: recognize a remaining time until an operation termination time of the home appliance based on the received operation information, based on the recognized remaining time reaching a first reference time, cause the fan to rotate, and based on a time elapsed from the operation termination time of the home appliance reaching a second reference time, cause the fan to stop rotating.

The at least one instruction, when executed by the at least one processor individually or collectively, may further cause the cooking apparatus to: maintain the standby mode based on the received operation information, and based on failing to recognize a home appliance capable of communicating with the communicator while executing the standby mode, terminate the standby mode.

The at least one instruction, when executed by the at least one processor individually or collectively, may further cause the cooking apparatus to: set the reference time interval for executing the standby mode based on a total operation time for an operation course of the home appliance.

The memory may store information on priorities of a plurality of home appliances including the home appliance, and the at least one instruction, when executed by the at least one processor individually or collectively, may further cause the cooking apparatus to: recognize home appliances capable of communicating with the communicator, recognize a home appliance having a highest priority from among the recognized home appliances based on the information on priorities, and set the reference time interval based on an operation course of the home appliance having the highest priority.

The cooking apparatus may further include an input interface configured to receive a user input, and the at least one instruction, when executed by the at least one processor individually or collectively, may further cause the cooking apparatus to set the reference time interval based on the user input received by the input interface.

The cooking apparatus may further include a temperature sensor inside the main body and configured to detect an internal temperature of the main body, and the at least one instruction, when executed by the at least one processor individually or collectively, may further cause the cooking apparatus to, based on the internal temperature detected by the temperature sensor while the fan rotates being lower than a reference temperature, cause the fan to stop rotating.

The cooking apparatus may further include: a humidity sensor inside the main body and configured to detect an internal humidity of the main body, and the at least one instruction, when executed by the at least one processor individually or collectively, may further cause the cooking apparatus to, based on the internal humidity detected by the humidity sensor while the fan rotates being lower than a reference humidity, cause the fan to stop rotating.

The at least one instruction, when executed by the at least one processor individually or collectively, may further cause the cooking apparatus to, based on operation information being received from another home appliance while executing the standby mode, extend an execution time of the standby mode and cause the fan to rotate based on the operation information received from the other home appliance.

The at least one instruction, when executed by the at least one processor individually or collectively, may further cause the cooking apparatus to: based on execution of the operation mode, control the communicator to communicate with the home appliance in real time, and cause the fan to rotate based on the received operation information.

The at least one instruction, when executed by the at least one processor individually or collectively, may further cause the cooking apparatus to: based on execution of the operation mode, control the communicator to communicate with the home appliance at a first time interval, and cause the fan to rotate based on the received operation information; and the first time interval may be shorter than the reference time interval.

The cooking apparatus may further include: a temperature sensor inside the main body, wherein the temperature sensor is configured to detect an internal temperature of the main body; and a humidity sensor inside the main body, wherein the humidity sensor is configured to detect an internal humidity of the main body. The at least one instruction, when executed by the at least one processor individually or collectively, may further cause the cooking apparatus to, while executing the operation mode: cause the fan to rotate based on the internal temperature detected by the temperature sensor exceeding a reference temperature or the internal humidity detected by the humidity sensor exceeding a reference humidity.

According to an aspect of the disclosure, a method of controlling a cooking apparatus includes: based on execution of a non-operation mode by the cooking apparatus, blocking power form being supplied to a coil of the cooking apparatus; based on the execution of the non-operation mode by the cooking apparatus, executing a standby mode; communicating with a home appliance at a reference time interval while executing the standby mode; and causing a fan of the cooking apparatus to rotate based on operation information received from the home appliance.

The causing the fan to rotate may include: recognizing a remaining time until an operation termination time of the home appliance based on the received operation information; based on the recognized remaining time reaching a first reference time, causing the fan to rotate; and based on a time elapsed from the operation termination time of the home appliance reaching a second reference time, causing the fan to stop rotating.

The method may further include: based on failing to recognize a home appliance capable of communicating with the cooking apparatus while executing the standby mode, terminating the standby mode; and maintaining the standby mode based on the received operation information.

The present disclosure may, when a temperature and a humidity of an installation space of a cooking apparatus increase by an operation of a home appliance installed in the same space, prevent damage to components of the cooking apparatus in a high-temperature and high-humidity environment. Therefore, the present disclosure may extend a life of the cooking apparatus and reduce a time and cost consumed for maintenance of the cooking apparatus.

The present disclosure may, while the cooking apparatus is in a non-operation mode, wake up the cooking apparatus periodically to cause the cooking apparatus to communicate with a home appliance periodically even in the non-operation mode, and because the cooking apparatus communicates with the home appliance periodically, the present disclosure may reduce power consumed for communication with the home appliance.

The present disclosure may, while the cooking apparatus is in the non-operation mode, cause the cooking apparatus to communicate with a home appliance periodically to monitor an operation state of the home appliance and perform cooling according to the monitored result. That is, the present disclosure may, while the cooking apparatus is in the non-operation mode, perform a cooling operation for maintenance of the cooking apparatus.

The present disclosure may improve safety of the cooking apparatus, improve quality and marketability of the cooking apparatus, and further secure competitiveness of the cooking apparatus.

### BRIEF DESCRIPTION OF THE DRAWINGS

The above and other aspects and features of certain embodiments of the present disclosure will be more apparent from the following description taken in conjunction with the accompanying drawings, in which:

FIG. 1 shows an example of a network system including a cooking apparatus according to an embodiment;

FIG. 2 shows an example of an appearance of a cooking apparatus according to an embodiment;

FIG. 3 shows inside of a cooking apparatus according to an embodiment;

FIG. 4 is a diagram for describing a container heating principle of a cooking apparatus according to an embodiment;

FIG. 5 is a cross-sectional view of a cooking apparatus according to an embodiment;

FIGS. 6, 7, and 8 show installation examples of a cooking apparatus according to an embodiment;

FIG. 9 is a control configuration diagram of a cooking apparatus according to an embodiment;

FIGS. 10 and 11 show examples of mode changes of a cooking apparatus according to an embodiment;

FIG. 12 is a control flowchart of an operation mode of a cooking apparatus according to an embodiment; and

FIG. 13 is a control flowchart of a non-operation mode of a cooking apparatus according to an embodiment.

### DETAILED DESCRIPTION

One or more embodiments of the present disclosure, and terms used herein, are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereinafter, the principles of operation and embodiments of the disclosure will be described with reference to the accompanying drawings.

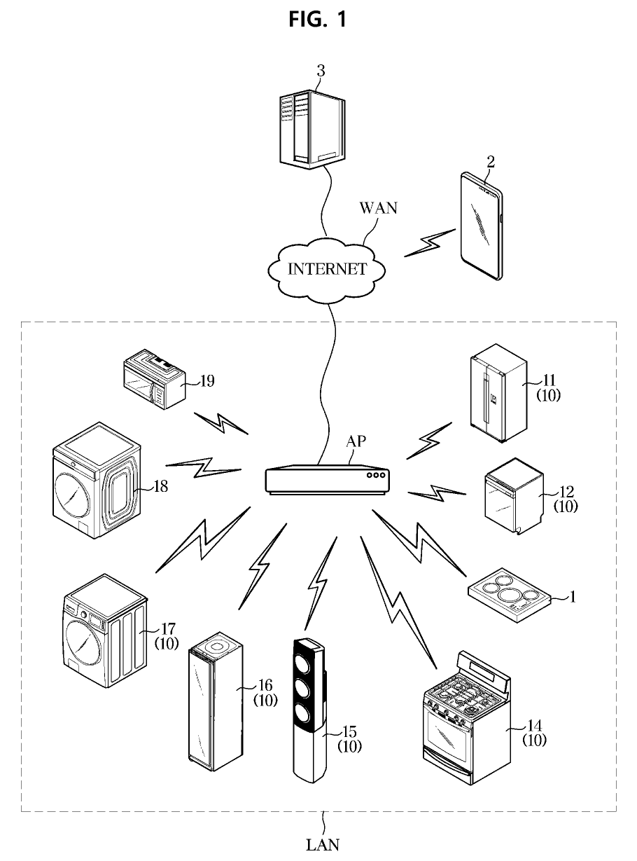

FIG. 1 shows an example of a network system including a cooking apparatus according to an embodiment.

A cooking apparatus 1 is an appliance that heats and cooks food. The cooking apparatus 1 according to an embodiment may include an electric range. The cooking apparatus 1 according to an embodiment may include an induction among electric ranges.

The cooking apparatus 1 may include a communication module capable of communicating with a home appliance 10, a user device 2, or a server 3, a user interface that receives a user input or outputs information to a user, at least one processor that controls an operation of the cooking apparatus 1, and at least one memory that stores a program for controlling the operation of the cooking apparatus 1.

The home appliance 10 may be a home appliance other than the cooking apparatus 1 according to an embodiment.

The home appliance 10 may be another cooking apparatus other than the cooking apparatus 1 according to an embodiment. For example, in a case where the cooking apparatus according to an embodiment is an induction, the other cooking apparatus may be an electric oven.

The home appliance 10 may include a communication module capable of communicating with the cooking apparatus 1, the other home appliance, the user device 2, or the server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric oven 14, an air conditioner 15, a clothes treating apparatus 16, a washing machine 17, a dryer 18, and a microwave oven 19, but is not limited thereto. For example, the home appliance 10 may include various types of appliances, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

Such appliances may be installed in a single home. Some of the appliances may be installed in the same space, while others may be installed in different spaces.

The server 3 may include a communication module communicating with another server, the cooking apparatus 1, the home appliance 10 or the user device 2, at least one processor that processes data received from the cooking apparatus 1, another server, the home appliance 10, or the user device 2, and at least one memory that stores programs for processing data or processed data.

The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the cooking apparatus 1 and the home appliance 10 in association with the user account, managing or controlling the registered cooking apparatus 1 and the home appliance 10, and the like. For example, a user may access the server 3 via the user device 2 and may create a user account. The user account may be identified by an identifier (ID) and a password set by the user.

The server 3 may register the cooking apparatus 1 and the home appliance 10 with the user account according to a predetermined procedure. For example, the server 3 may link identification information of the cooking apparatus 1 and the home appliance 10 (e.g., a serial number or MAC address) to the user account to register, manage, and control the cooking apparatus 1 and the home appliance 10.

The user device 2 may include a communication module capable of communicating with the cooking apparatus 1, the home appliance 10, or the server 3, a user interface that receives a user input or outputs information to a user, at least one processor that controls an operation of the user device 2, and at least one memory that stores a program for controlling the operation of the user device 2.

The user device 2 may be carried by a user, or placed in a user’s home or office, or the like. The user device 2 may include a personal computer (PC), a terminal, a portable telephone, a smartphone, a handheld device, a wearable device, and the like, but is not limited thereto.

The memory of the user device 2 may store a program for controlling the cooking apparatus 1 and the home appliance 10, i.e. an application. The application may be sold installed on the user device 2, or may be downloaded from an external server for installation.

By running the application installed on the user device 2 by a user, the user may access the server 3, create a user account, and communicate with the server 3 based on the login user account to register the cooking apparatus 1 and the home appliance 10.

For example, by operating the cooking apparatus 1 and the home appliance 10 to allow the cooking apparatus 1 and the home appliance 10 to access the server 3 according to a procedure guided by the application installed on the user device 2, the server 3 may register the cooking apparatus 1 and the home appliance 10 with the user account by assigning the identification information (e.g., a serial number or a MAC address) of the cooking apparatus 1 and the home appliance 10 to the corresponding user account.

A user may control the cooking apparatus 1 and the home appliance 10 using the application installed on the user device 2. For example, by logging into a user account with the application installed on the user device 2, the cooking apparatus 1 and the home appliance 10 registered in the user account appears, and by inputting a control command for the cooking apparatus 1 and the home appliance 10, the control command may be delivered to the cooking apparatus 1 and the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth (IEEE 802.15.1), Zigbee (IEEE 802.15.4), Wi-Fi Direct, near field communication (NFC), and Z-Wave, but is not limited thereto.

The AP may connect the cooking apparatus 1, the home appliance 10 or the user device 2 to a WAN connected to the server 3. The cooking apparatus 1, the home appliance 10 or the user device 2 may be connected to the server 3 via a WAN.

The AP may communicate with the cooking apparatus 1, the home appliance 10 or the user device 2 using wireless communication, such as Wi-Fi (IEEE 802.11), Bluetooth (IEEE 802.15.1), Zigbee (IEEE 802.15.4), and the like, and access a WAN using wired communication, but is not limited thereto.

According to one or more embodiments, the cooking apparatus 1 and the home appliance 10 may be directly connected to the user device 2 or the server 3 without going through an AP.

The cooking apparatus 1 and the home appliance 10 may be connected to the user device 2 or the server 3 via a long-range wireless network or a short-range wireless network.

For example, the cooking apparatus 1 and the home appliance 10 may be connected to the user device 2 via a short-range wireless network (e.g., Wi-Fi Direct).

In another example, the cooking apparatus 1 and the home appliance 10 may be connected to the user device 2 or the server 3 via a WAN using a long-range wireless network (e.g., a cellular communication module).

In still another example, the cooking apparatus 1 and the home appliance 10 may access a WAN using wired communication, and may be connected to the user device 2 or the server 3 via a WAN.

When accessing a WAN using wired communication, the cooking apparatus 1 and the home appliance 10 may also act as an AP. Accordingly, the cooking apparatus 1 and the home appliance 10 may connect another home appliance to a WAN to which the server 3 is connected. In addition, another home appliance may connect the cooking apparatus 1 and the home appliance 10 to the WAN to which the server 3 is connected.

The cooking apparatus 1 and the home appliance 10 may transmit information about an operation or state to other home appliances, the user device 2, or the server 3 via the network. For example, the cooking apparatus 1 and the home appliance 10 may transmit information about an operation or state to other home appliances, the user device 2 or the server 3 upon receiving a request from the server 3, in response to an event in the home appliance 10, or periodically or in real time.

Upon receiving the information about the operation or state from the cooking apparatus 1 and the home appliance 10, the server 3 may update the stored information about the operation or state of the cooking apparatus 1 and the home appliance 10 and transmit the updated information about the operation and state of the cooking apparatus 1 and the home appliance 10 to the user device 2 via the network. Here, updating the information may include various operations in which existing information is changed, such as adding new information to the existing information, replacing the existing information with new information, and the like.

The home appliance 10 may obtain various information from the cooking apparatus 1, other home appliances, the user device 2, or the server 3, and may provide the obtained information to a user. For example, the home appliance 10 may obtain information related to a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the cooking apparatus 1 and the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the cooking apparatus 1, the home appliance 10 or the server 3 via the communication module. For example, the user device 2 may transmit information about a user’s location, a user’s health condition (i.e., state), a user’s preference, a user’s schedule, and the like to the server 3. The user device 2 may transmit information about the user to the server 3 based on the user’s prior authorization.

The cooking apparatus 1, the home appliance 10, the user device 2, or the server 3 may use techniques, such as artificial intelligence (AI) to determine a control command. For example, the server 3 may receive information about an operation or a state of the cooking apparatus 1, the home appliance 10 or information about a user of the user device 2, process the received information using techniques, such as AI, and transmit a processing result or a control command to the cooking apparatus 1, the home appliance 10 or the user device 2 based on the processing result.

Hereinafter, the cooking apparatus 1 according to an embodiment is described in detail with reference to accompanying drawings.

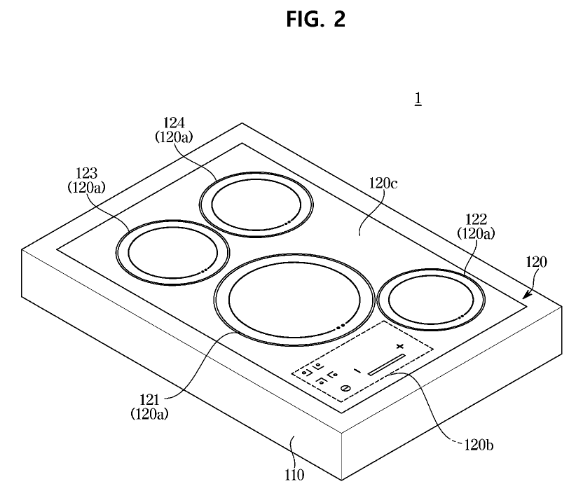

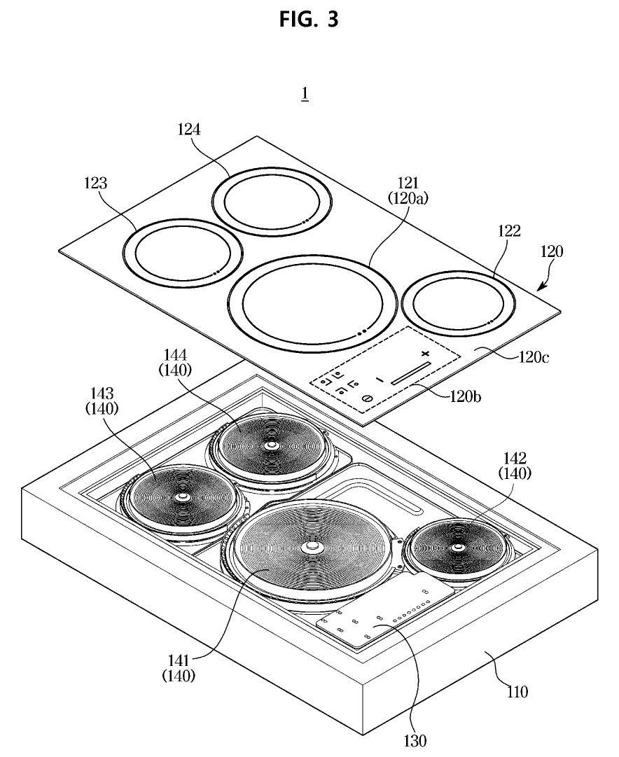

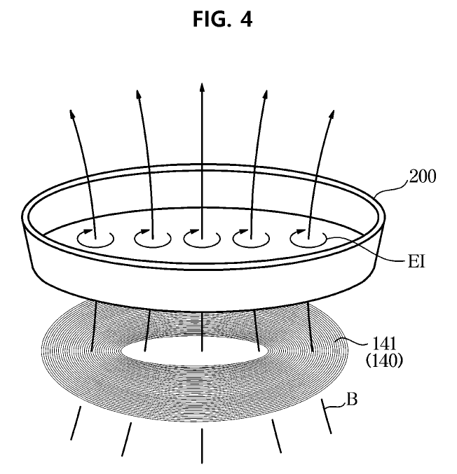

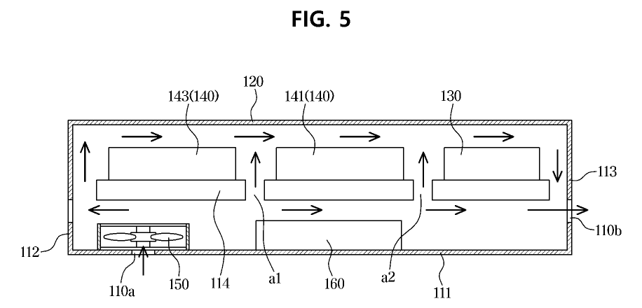

FIG. 2 shows an example of an appearance of a cooking apparatus according to an embodiment. FIG. 3 shows inside of a cooking apparatus according to an embodiment. FIG. 4 is a diagram for describing a container heating principle of a cooking apparatus according to an embodiment. FIG. 5 is a cross-sectional view of a cooking apparatus according to an embodiment.

As shown in FIG. 2, a cooking apparatus 1 may include a main body 110 that forms an appearance of the cooking apparatus 1 and accommodates various components constructing the cooking apparatus 1.

The main body 110 may be formed in a substantially box shape. The main body 110 may include a front frame, a rear frame facing the front frame, first and second side frames respectively provided at both sides of the front frame and the rear frame, and a lower frame provided at lower portions of the front frame, the rear frame, and the first and second side frames, more specifically, at lower edges of the front frame, the rear frame, and the first and second side frames.

A top plate 120 which has a flat plate shape and on which a container is placed may be provided on an upper surface of the main body 110.

The top plate 120 may be made of tempered glass such as ceramic glass to prevent breakage.

The top plate 120 may include a first area 120a which corresponds to a position of at least one coil and on which a container is placed, a second area 120b as a user interface area to which a command for operating the cooking apparatus is input and on which operation information is output, and a third area 120c which is an area excluding the first area 120a and the second area 120b from an entire area.

Here, coil position marks 121, 122, 123, and 124, indicating positions on which containers are placed, may be formed in the first area 120a, and input/output position marks indicating input/output positions may be formed in the second area 120b.

As shown in FIG. 3, a user interface 130, a coil portion 140, a fan 150, and a circuit board 160 may be provided in an inside space of the main body 110 below the top plate 120.

The user interface 130 may include an input interface for receiving an operation command from a user and an output device for outputting operation information of the cooking apparatus.

The output device may include at least one of a display that outputs operation information as light or an image, or a speaker that outputs operation information as a sound.

The input interface of the user interface may include a touch panel that recognizes a touch position, and the display may include a display panel integrated into the touch panel.

That is, the user interface 130 may be provided as a touch screen into which a touch panel and a display panel are integrated, and an image on the touch screen may be projected to outside through the second area 120b of the top plate.

The input interface of the user interface 130 may include a plurality of touch pads that detect a touch, and the display may include at least one of a plurality of light-emitting diodes or a plurality of 7-segments.

The plurality of touch pads may receive a touch signal for power on/off, a touch signal corresponding to a selection of a coil position, and a touch signal corresponding to a selection of an output level.

The plurality of light-emitting diodes may be arranged adjacent to the plurality of touch pads and may display power on/off information, coil selection information, and coil output level information.

Light emitted from the plurality of light-emitting diodes may be output to the outside by being transmitted through the second area 120b of the top plate.

In addition, on the second area 120b of the top plate, operation command symbols indicating positions for inputting operation commands and operation information symbols indicating output level magnitudes may be formed.

For example, the operation command symbols may include a power on/off symbol and a coil position symbol, and the operation information symbols may include output level increase and decrease symbols.

In addition, the user interface 130 may be provided at various locations of the main body 110 such as a front or side surface of the main body 110.

Also, the input interface of the user interface 130 may be provided as at least one button, a switch, or at least one jog dial.

The coil portion 140 may include a plurality of coils 141, 142, 143, and 144.

Here, the plurality of coils 141, 142, 143, and 144 may be provided in the inside space of the main body 110 and may be arranged at positions corresponding to the coil position marks 121, 122, 123, and 124 in the first area 120a of the top plate.

The plurality of coils 141, 142, 143, and 144 of the coil portion may have the same size and the same number of turns.

Also, the plurality of coils 141, 142, 143, and 144 of the coil portion may have different sizes and the different numbers of turns, and accordingly, the plurality of coils 141, 142, 143, and 144 may have different maximum output levels.

Also, the coil portion 140 may be configured as a single coil.

Each coil of the coil portion 140 may form a magnetic field when current is supplied to the coil, and a container may be heated by the formed magnetic field. This will be described in more detail with reference to FIG. 4.

A principle of heating a container may be the same for all the coils that heat the container. Accordingly, a container heating principle of a first coil 141 of the plurality of coils will be described.

As shown in FIG. 4, while current is supplied to a wound wire of the first coil 141, the first coil 141 may generate a magnetic field B that is transmitted through inside of the coil according to Ampere’s law.

In this case, the magnetic field B formed in the first coil 141 may be transmitted through a bottom of a container 200.

The current applied to the first coil 141 may be current of which a direction changes over time, that is, alternating current.

Accordingly, the magnetic field formed in the first coil 141 may also change over time.

That is, while the magnetic field B changing over time is transmitted through the inside of the first coil 141, current rotating around the magnetic field B may be generated in the bottom of the container 200.

Here, the current rotating around the magnetic field may be current formed by a voltage generated in a direction that interferes with a change in the magnetic field B of the first coil 141, and the current may be called eddy current EI.

The bottom of the container 200 may be heated by the eddy current EI.

In other words, while eddy current EI flows through the container 200 having electrical resistance, heat may be generated according to Ohm’s law, and, as a result, the container 200 may be heated.

A phenomenon in which current is induced by a magnetic field B that changes over time is called electromagnetic induction.

As such, the cooking apparatus 1 may selectively supply current to at least one coil among the plurality of coils 141, 142, 143, and 144 and heat the container 200 by a magnetic field B generated by the at least one coil.

Here, the at least one coil that supplies current may be a coil selected by the user or a coil placed at a detected position on which the container is placed.

As shown in FIG. 5, the main body 110 may include an inlet 110a through which air flows into inside of the main body 110 and an outlet 110b through which air is discharged to outside of the main body 110.

As an example, the inlet 110a may be provided in a lower frame 111 of the main body 110, and the outlet 110b may be provided in first and second side frames 112 and 113 of the main body 110.

As another example, the inlet may be provided in a front frame of the main body, and the outlet may be provided in a rear frame. As another example, the outlet may be provided in the rear frame of the main body, and the inlet may be provided in the front frame. As such, the inlet 110a and the outlet 110b may be provided at various locations.

The cooking apparatus may further include a support plate 114 that is provided in the inside space of the main body 110 and partitions the inside space of the main body 110 into a plurality of spaces.

The support plate 114 may be positioned inside the main body 110 in such a way that at least a part of the support plate 114 is spaced apart from an inner wall of the main body 110.

The coil portion 140 and the user interface 130 may be positioned on the support plate 114. The coil portion 140 and the user interface 130 may be positioned on the support plate 114 in such a way as to face a lower side of the top plate 120. The coil portion 140 and the user interface 130 may be positioned on the support plate 114 in such a way as to be spaced apart from the top plate 120.

The support plate 114 may have a material with excellent thermal conductivity. The material of the support plate 114 may include, but is not limited to, aluminum, gold, silver, and copper.

Also, the support plate 114 may have a material capable of securing a shield effect. That is, the support plate 114 may have a material suitable for protecting components of the cooking apparatus from leakage magnetic flux or noise that may occur in the coil portion 140.

A plurality of openings a1 and a2 may be provided in the support plate 114. The spaces provided inside the main body 110 may communicate with each other by the plurality of openings a1 and a2.

The cooking apparatus 1 may further include the fan 150 that blows air to lower temperatures of the main body 110 and other components when the temperature of the main body 110 of the cooking apparatus 1 rises by an operation of the coil portion 140.

The fan 150 may be provided in the inside space of the main body 110. The fan 150 may be installed in a space that is different from a space in which the coil portion 140 and the user interface 130 are installed among the inside spaces of the main body 110 divided by the support plate 114.

The fan 150 may be installed at the inlet 110a of the main body or around the inlet.

The fan 150 may be installed on the first side frame or the second side frame of the main body 110 or may be installed on the front frame or the rear frame. The fan 150 may be positioned at various locations.

The fan 150 may cause outside air to flow to the inside space of the main body through the inlet 110a and circulate in the inside space of the main body and cause the air circulating in the inside space of the main body 110 to be discharged to the outside of the main body 110 through the outlet 110b.

Air received through the fan 150 and flowing inside the main body may freely circulate inside the main body 110 by passing through the plurality of openings a1 and a2 formed in the support plate 114. Therefore, the fan 150 may further improve efficiency of cooling components inside the main body 110.

The cooking apparatus 1 may further include the circuit board 160 connected to the user interface 130, the coil portion 140, and the fan 150 and provided with a processor and memory for controlling operations of the user interface 130, the coil portion 140, and the fan 150.

The circuit board 160 may be provided in the inside space of the main body 110, more particularly, on the lower frame 111.

The circuit board 160 may be provided on the support plate 114.

The circuit board 160 may include a printed circuit board and a flexible circuit board.

A material of the circuit board 160 may include at least one of paper phenol, paper epoxy, glass epoxy, alumina, or Teflon.

The components of the cooking apparatus according to the present embodiment may include the circuit board 160, the user interface 130, and the coil portion 140. The circuit board 160, the user interface 130, and the coil portion 140 may be cooled by the fan 150.

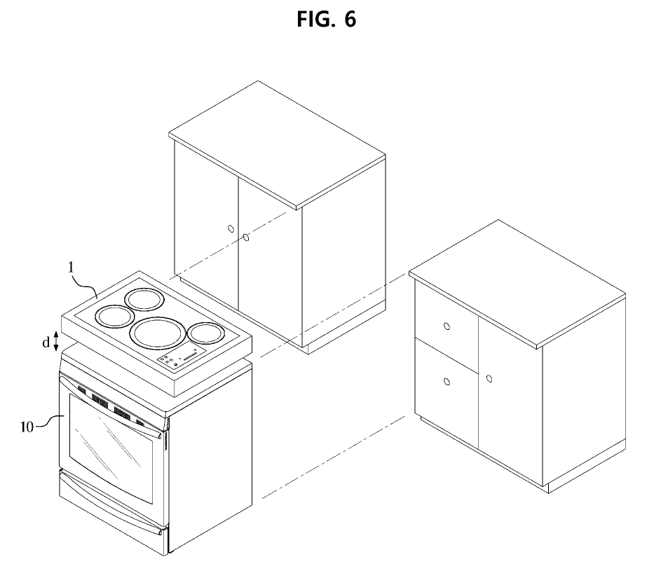

As shown in FIG. 6, the cooking apparatus 1 may be installed in a home in a built-in manner.

The cooking apparatus 1 may be positioned adjacent to furniture or a home appliance in a certain space inside the home. Here, the certain space inside the home may be a room or a kitchen.

The cooking apparatus 1 may be spaced a preset distance apart from surrounding furniture and may be spaced a preset distance apart from a rear wall.

For example, the cooking apparatus 1 may be placed in the same space as at least one of an air conditioner 15, a clothes treating apparatus 16, a refrigerator, an air purifier, a dehumidifier, or a humidifier.

In a case where the cooking apparatus 1 is placed in the certain space, the cooking apparatus 1 may be stacked on a home appliance 10. The cooking apparatus 1 may be placed above the home appliance 10 in such a way as to be spaced a preset distance d apart from the home appliance 10.

For example, the cooking apparatus 1 may be stacked on at least one of a dishwasher 12, an electric oven 14, a washing machine 17, a dryer 18, or a microwave oven 19.

When an environment of the space changes to a high temperature and high humidity environment due to an operation of the home appliance placed in the same space as the cooking apparatus, the components of the cooking apparatus 1 may be affected by heat and moisture.

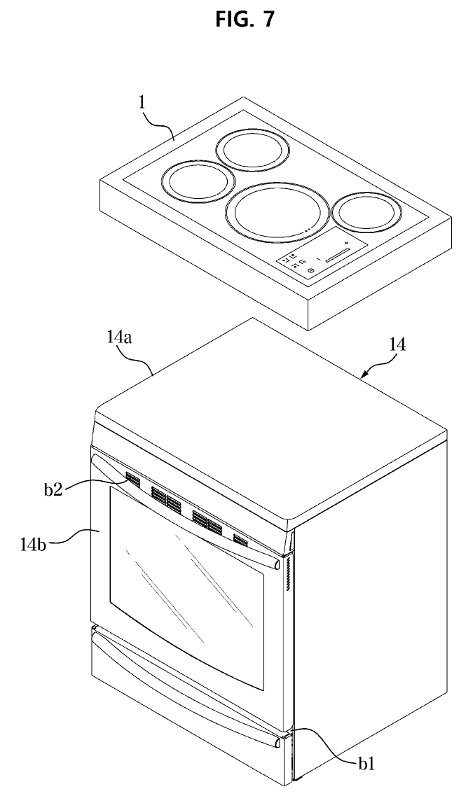

As shown in FIG. 7, the cooking apparatus 1 may be placed above the electric oven 14. The cooking apparatus 1 may be spaced a preset distance apart from the electric oven 14. By spacing the cooking apparatus 1 apart from the electric oven 14 by the preset distance, a ventilation space may be formed between the cooking apparatus 1 and the electric oven 14.

The electric oven 14 may include a housing 14a having an opening for putting food into or taking food out of the housing 14a and a cooking room for storing food, and a door 14b provided on the opening to open or close the cooking room.

When food is stored in the cooking room and the cooking room is sealed by the door 14b, the electric oven 14 may generate heat and cook the food with the heat generated.

The door 14b may be hinge-coupled to the housing 14a in such a way as to be rotatable with respect to the housing 14a.

The door 14b may be opened automatically based on cooking completion of food.

The door 14b may include a door intake opening b1 located at an outer lower end of the door 14b to receive air toward inside of the door 14b, and a door exhaust opening b2 located at an outer upper end of the door 14b to discharge air received through the door intake opening b1 to the outside.

Air received through the door intake opening b1 may exchange heat with high-temperature air of the cooking room at the inside of the door 14b.

Air inside the cooking room may be discharged to the outside through the door exhaust opening b2 based on cooking completion.

The electric oven 14 may include one or more heaters that are positioned adjacent to an upper side of the cooking room and generate heat to provide heat into the cooking room, and a fan that circulates air inside the cooking room.

The electric oven 14 may further include a magnetron that generates heat by generating electromagnetic waves to rotate water molecules inside the food, and a steam device that generates steam.

The electric oven 14 may further include a user interface that receives a user input and displays cooking information of the electric oven.

The user input may include a cooking course, a cooking temperature, a cooking time, a cooking start command, and a cooking stop command.

The cooking information may include information on a cooking course, a cooking temperature, a cooking start time, an elapsed time, a remaining time, a cooking completion time, etc.

The electric oven 14 may control operations of the heaters and fan based on a user input.

The electric oven 14 may control opening of the door 14b based on cooking completion to allow air inside the cooking room to be discharged to the outside.

The electric oven 14 may also control the fan to discharge air in the cooking room to the outside through the door exhaust opening b2 based on cooking completion.

The electric oven 14 may communicate with the cooking apparatus 1, recognize a total cooking time required for cooking based on a cooking course, recognize a remaining time based on the total cooking time and an elapsed time, and transmit information about the recognized remaining time to the cooking apparatus 1.

The electric oven 14 may also transmit information about a cooking course to the cooking apparatus 1.

The information about the cooking course may include information on a total time required to cook food.

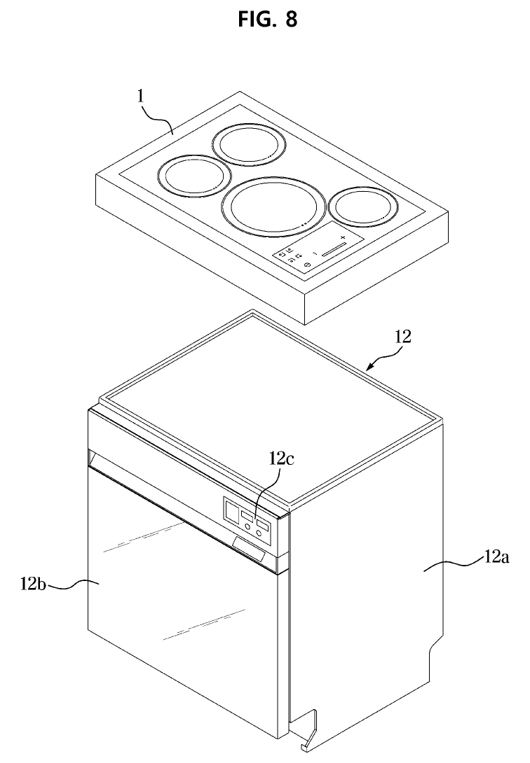

As shown in FIG. 8, the cooking apparatus 1 may be placed above the dishwasher 12. The cooking apparatus 1 may be spaced a preset distance apart from the dishwasher 12. By spacing the cooking apparatus 1 apart from the dishwasher 12 by the preset distance, a ventilation space may be formed between the cooking apparatus 1 and the dishwasher 12.

The dishwasher 12 may include a housing 12a, a door 12b, and a user interface 12c.

The housing 12a may form an appearance of the dishwasher 12.

An opening may be formed in one side of housing 12a, and a washing tank that is opened and closed by the door 12b may be provided inside the housing 12a.

The door 12b may be hinge-coupled to a lower portion of the housing 12a. The door 12b may be automatically opened.

A storage portion may include a plurality of baskets and cutlery that are arranged in such a way as to be spaced apart from each other inside the washing tank, slide back and forth, have holes with various sizes, and store dishes, etc.

The dishwasher 12 may perform washing, rinsing, and drying cycles.

The user interface 12c may be provided on the housing 12a and receive and display operation information of the dishwasher.

The user interface 12c may receive operation information, such as various washing courses (e.g., a standard course, a manual course, etc.) and additional rinsing, according to a user input, display information on an operation in progress, and display error information when an error occurs.

Each washing course may include a washing cycle of spraying washing water to dishes to wash the dishes, a rinsing cycle of spraying rinsing water to the dishes to rinse the dishes, and a drying cycle of drying the rinsed dishes.

The dishwasher 12 may perform a washing cycle of receiving water, spraying the received water onto dishes while circulating the water to wash the dishes, and discharging the washing water to outside when a washing time has elapsed, a rinsing cycle of receiving water, spraying the received water onto the dishes while circulating the water to rinse the dishes, and discharging the rinsing water to the outside when rinsing is complete, and a drying cycle of drying the rinsed dishes and discharging water (condensed water) generated during the drying process to the outside when a drying time has elapsed.

Here, the washing cycle may include a preliminary washing cycle that is performed during a preliminary washing time and a main washing cycle that is performed for a longer time than the preliminary washing time.

Also, the rinsing cycle may include a normal rinsing cycle that rinses dishes a selected number of times with rinsing water at a preset temperature, and a high-temperature rinsing cycle that rinses dishes with rinsing water at a target temperature higher than the preset temperature.

In addition, a time for the high-temperature rinsing cycle may be shorter than a time for the normal rinsing cycle.

During the drying cycle, the dishwasher 12 may automatically open the door 12b to allow steam inside the main body to be discharged to the outside.

The dishwasher 12 may open the door 12b to a preset angle before the drying cycle is completed.

The dishwasher 12 may communicate with the cooking apparatus 1, recognize a total washing time required to wash dishes based on a washing course, recognize a remaining time based on the total washing time and an elapsed time, and transmit information on the recognized remaining time to the cooking apparatus 1.

The dishwasher 12 may also transmit information on the washing course to the cooking apparatus 1. The information on the washing course may include information on a total time required to wash dishes.

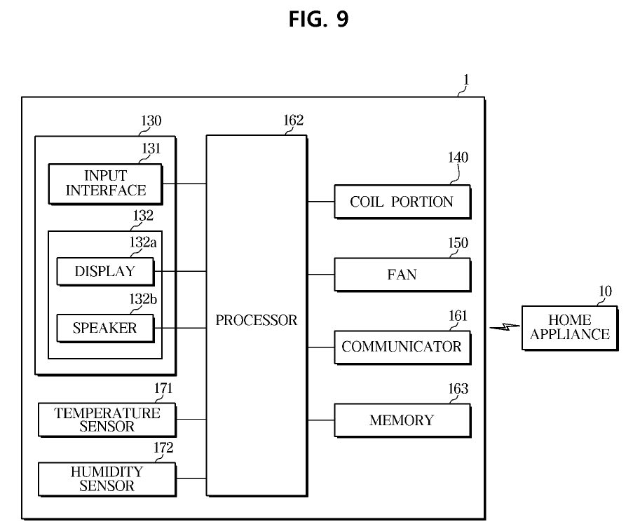

FIG. 9 is a control configuration diagram of a cooking apparatus according to an embodiment.

The cooking apparatus 1 may include the user interface 130, the coil portion 140, the fan 150, a communicator 161, a processor 162, and memory 163, and may further include a temperature sensor 171 and a humidity sensor 172.

The user interface 130 may receive a user input and output various information regarding operations of the cooking apparatus 1.

The user interface 130 may include an input interface 131 and an output device 132.

The input interface 131 may receive a user input and transmit the received user input to the processor 162.

The input interface 131 may receive coil selection information corresponding to a selection of at least one coil.

The input interface 131 may receive at least one of a cooking start command, a cooking pause command, a cooking stop command, a cooking mode, or option information.

Here, the cooking mode may include a boiling mode, a stew mode, a frying mode, a steaming mode, a stir-fry mode, a baking mode, and a warming mode. The option information may include a cooking temperature and a cooking time.

The input interface 131 may include, in addition to a button and a jog dial, a hardware device, such as a switch, a pedal, a keyboard, a mouse, a trackball, various levers, a handle, or a stick.

Furthermore, the input interface 131 may include a Graphical User Interface (GUI) such as a touch pad, that is, a software device. The touch pad may be implemented as a Touch Screen Panel (TSP) and form an inter-layer structure with the display.

The output device 132 may output operation information of the cooking apparatus 1.

The output device 132 may include a display 132a and a speaker 132b.

The display 132a may display operation information of the cooking apparatus, display position information of an operating coil, display a remaining time and a cooking temperature for each operating coil, and also display a cooking mode and option information for each coil.

The display 132a may display a cooking temperature in degrees Celsius or display a cooking temperature as a cooking temperature level. Here, the cooking temperature level may include an output level of the coil.

The display 132a may also display information regarding communication with a home appliance.

The display 132a may display information indicating whether communication with a home appliance is performed and identification information of a home appliance in communication.

The display 132a may also display guidance information corresponding to execution of a cooling mode.

The guidance information corresponding to the execution of the cooling mode may include an emoticon image of the fan and may include text.

The display 132a may include a plurality of 7-segments.

The display 132a may be provided as, but is not limited to, a Liquid Crystal Display (LCD), a Digital Light Processing (DLP) panel, a Plasma Display Panel, an Electro Luminescence (EL) panel, an Electrophoretic Display (EPD) panel, an Electrochromic Display (ECD) panel, a Light Emitting Diode (LED) panel, or an Organic Light Emitting Diode (OLED) panel.

The speaker 132b may output notification sounds corresponding to a cooking start, cooking completion, and cooking pause of the cooking apparatus.

The speaker 132b may also output a notification sound corresponding to a change in cooking temperature of the cooking apparatus.

The speaker 132b may also output a guidance sound corresponding to execution of the cooling mode.

The coil portion 140 may include one or more coils. Each coil may generate a magnetic field when current is supplied thereto based on a control command from the processor 162. At this time, a container may be heated by the magnetic field formed in the coil.

The cooking apparatus may further include a coil driver for applying current to the coil portion 140. The number of coil drivers may be the same as the number of coils. That is, each coil driver may apply current to a coil matching with the coil driver and adjust a magnitude of the current applied to the coil to heat a container to a selected cooking temperature through the coil.

The coil driver may include one or more switching elements and may control a magnitude of current that is applied to the coil by turning on or off the one or more switching elements based on a control command from the processor.

The cooking apparatus may further include a current sensor that detects current flowing through each of the one or more coils. That is, the number of current sensors may be the same as the number of the coils.

Each current sensor may be connected to a coil matching with the current sensor, detect current flowing through the matching coil, and transmit current information on the detected current to the processor 162.

For example, the current sensor may include a current transformer (CT) that reduces current in proportion to a magnitude of current flowing through the coil, and an ampere meter that detects a magnitude of the proportionally reduced current.

As another example, the current sensor may include a shunt resistance connected to the coil, and a measuring device that measures a voltage drop occurring in the shunt resistance.

The fan 150 may rotate based on a control command from the processor 162.

The fan 150 may rotate at a rotation speed corresponding to a control command from the processor 162 and may rotate in a direction corresponding to a control command from the processor 162.

The communicator 161 may include various communication circuits for performing wired and/or wireless communication with an external device (e.g., a server, a user device, and/or a home appliance). The user device may include various electronic devices, such as a smartphone, a notebook, a laptop, a smartwatch, a desktop tablet, and a speaker.

The communicator 161 may include at least one of a short-range communication circuit or a long-range communication circuit.

The communicator 161 may transmit data to an external device or receive data from an external device. For example, the communicator 161 may support cellular communication, wireless local area network (WLAN), Home Radio Frequency (RF), infrared communication, Ultra-wide band (UWB) communication, Wi-Fi, Wi-Fi Direct, Bluetooth, AD-HOC, and/or Zigbee. Communication technologies supported by the communicator 161 are not limited to the above examples.

The communicator 161 may also communicate with an external device via an Access Point (AP). The AP may connect a local area network (LAN) to which the cooking apparatus 1 is connected to a wide area network (WAN) to which a server is connected. The cooking apparatus 1 may be connected to the server through the WAN.

The communicator 161 may wake up based on a control command from the processor 162 and attempt to establish a communication connection with a home appliance based on a control command from the processor 162.

The communicator 161 may communicate with the home appliance through a hub (or router) or may communicate with the home appliance through a communication protocol.

The cooking apparatus 1 may include a temperature sensor 171 that is provided in the main body 110, detects an ambient temperature, and transmits temperature information about the detected temperature to the processor 162.

The cooking apparatus 1 may include a humidity sensor 172 which is provided in the main body 110, detects ambient humidity, and transmits humidity information about the detected humidity to the processor 162.

The processor 162 may be electrically connected to various components and/or devices of the cooking apparatus 1 and may control the various components and/or devices.

The processor 162 may be electrically connected to the user interface 130, the coil portion 140, the fan 150, the communicator 161, the temperature sensor 171, and the humidity sensor 172, and may control the user interface 130, the coil portion 140, the fan 150, the communicator 161, the temperature sensor 171, and the humidity sensor 172.

The processor 162 may control overall operations of the cooking apparatus 1. The processor 162 may be a single or a plurality of processors.

According to the processor 162 receiving a power-on command through the input interface 131, the processor 162 may execute an operation mode.

While the processor 162 executes the operation mode, according to the processor 162 receiving coil selection information and a cooking temperature through the input interface 131, the processor 162 may transmit a control signal to a coil driver to apply current corresponding to the received cooking temperature to a selected coil.

When the processor 162 transmits a control signal to the coil driver, the processor 162 may transmit a control signal for controlling a turn-on operation of a switching element.

The processor 162 may recognize a coil on which a container is placed based on current information received from a current sensor connected to each coil and transmit a control signal to a coil driver connected to the recognized coil.

The processor 162 may recognize whether a container is a heatable container based on the current information received from the current sensor connected to each coil, and according to the container being recognized as a non-heatable container, the processor 162 may control the coil driver to cut off current applied to the coil and output information indicating that the container is not heatable.

The processor 162 may recognize an execution time of the operation mode and rotate the fan 150 when the recognized execution time reaches a preset time.

The preset time may vary depending on the number of coils that execute the operation mode. For example, in a case where there is one coil that executes the operation mode, the preset time may be a first time. In a case where there are two coils that execute the operation mode, the preset time may be a second time. Here, the first time may be longer than the second time.

The preset time may vary depending on a cooking temperature of the coil. For example, in a case where a cooking temperature of the coil is 100 degrees, the preset time may be a third time. In a case where a cooking temperature of the coil is 150 degrees, the preset time may be a fourth time. Here, the third time may be longer than the fourth time.

The preset time may vary depending on a cooking mode of the coil. For example, in a case where the cooking mode is the warming mode, the preset time may be a fifth hour. In a case where the cooking mode is a steaming mode, the preset time may be a sixth hour. Here, the fifth hour may be longer than the sixth hour.

The preset time may be information obtained and stored through a test and may be a time for which the user interface 130, the circuit board 160, etc., may be damaged by heat generated from the cooking apparatus 1.

The preset time may be information obtained and stored through a test and may be a time for which the user interface 130, the circuit board 160, etc., may be damaged by heat generated from the cooking apparatus 1 or steam generated from the container.

When a detected temperature is below a reference temperature based on temperature information detected by the temperature sensor 171 while the processor 162 executes the operation mode, the processor 162 may rotate the fan 150.

When detected humidity is below reference humidity based on humidity information detected by the humidity sensor 172 while the processor 162 executes the operation mode, the processor 162 may rotate the fan 150.

The processor 162 may recognize an execution time of the operation mode, and when the recognized execution time reaches a preset time, the processor 162 may transmit an execution command for the cooling mode to the home appliance 10. Therefore, by causing the home appliance 10 located adjacent to the cooking apparatus to execute the cooling mode, the home appliance 10 may be prevented from being damaged by at least one of heat or steam generated by the cooking apparatus.

While the processor 162 executes the operation mode or a non-operation mode, the processor 162 may control the fan 150 based on operation information of the home appliance 10 to cool the cooking apparatus. This will be described in more detail below.

Hereinafter, a configuration of the processor 162 that controls the fan 150 based on operation information of the home appliance 10 while executing the operation mode will be described.

The processor 162 may communicate with at least one home appliance 10 while executing the operation mode.

The processor 162 may communicate with the at least one home appliance 10 in real time while executing the operation mode.

The processor 162 may communicate with the at least one home appliance 10 at a first time interval while executing the operation mode.

The at least one home appliance 10 may include an appliance positioned within a preset distance from the cooking apparatus 1. The preset distance may be a distance at which at least one of heat or steam generated from the home appliance may reach the cooking apparatus 1. The preset distance may be information obtained and stored through a test.

The at least one home appliance 10 may include an appliance selected by a user.

The processor 162 may recognize at least one home appliance 10 that is within a preset distance from the cooking apparatus 1 based on distance information of each home appliance received through the input interface 131, and store identification information of the recognized at least one home appliance 10.

The processor 162 may recognize home appliances 10 capable of communicating with the cooking apparatus 1 and transmit communication signals to the home appliances 10 capable of communicating with the cooking apparatus 1, and, according to response signals being received from the home appliances 10 capable of communicating with the cooking apparatus 1, the processor 162 may recognize distances to the home appliances 10 capable of communicating with the cooking apparatus 1 based on received signal strengths of the received response signals and recognize at least one home appliance of which a recognized distance is within the preset distance among the home appliances capable of communicating with the cooking apparatus 1.

The recognized at least one home appliance 10 may be an appliance which is placed adjacent to the cooking apparatus 1 in the same space as the cooking apparatus 1 and needs to be monitored for cooling control of the cooking apparatus.

The processor 162 may recognize whether the recognized at least one home appliance is a home appliance that generates at least one of heat or steam based on identification information of the recognized at least one home appliance, and according to the recognized at least one home appliance being recognized as a home appliance that generates at least one of heat or steam, the processor 162 may store the identification information of the recognized home appliance.

The identification information of the home appliance may include a name and model name of the home appliance, may further include information on a total operation time for each operation course, and may further include information on a temperature of generated heat and an amount of generated steam for each operation course.

The processor 162 may recognize a distance to a home appliance 10 placed adjacent to the cooking apparatus and an operation course of the home appliance 10 whenever communicating with the home appliance 10, without storing identification information of the home appliance 10.

The processor 162 may communicate with the at least one home appliance 10 while executing the operation mode and request operation information from the at least one home appliance 10, and according to the operation information being received from the at least one home appliance 10, the processor 162 may rotate the fan 150 based on the received operation information.

While the processor 162 executes the operation mode, the processor 162 may recognize an operation start time and a total operation time based on the received operation information, recognize a remaining time based on the recognized operation start time and total operation time, and rotate the fan 150 based on the recognized remaining time.

While the processor 162 executes the operation mode, the processor 162 may recognize an operation course of the home appliance based on the received operation information and recognize whether the recognized operation course of the home appliance is an operation course that requires monitoring, and according to the recognized operation course of the home appliance being recognized as an operation course that requires monitoring, the processor 162 may recognize an operation start time and a total operation time based on the received operation information.

The operation course that requires monitoring may include an operation course that generates at least one of heat or steam. For example, in a case where the home appliance is a washing machine having a drying function, the operation course that requires monitoring may include a drying course. As another example, in a case where the home appliance is an air conditioner, the operation course that requires monitoring may include a dehumidifying course that generates heat in a dehumidifying process.

While the processor 162 executes the operation mode, the processor 162 may request a remaining time from the at least one home appliance 10, and according to the remaining time being received from the at least one home appliance 10, the processor 162 may rotate the fan 150 based on the received remaining time.

Based on the remaining time of the home appliance reaching a first reference time while the processor 162 executes the operation mode, the processor 162 may rotate the fan 150.

According to operation termination information of a home appliance being received from the home appliance while the processor 162 executes the operation mode and the cooling mode, the processor 162 may count a time elapsed from a time at which the operation termination information is received and, based on the counted time reaching a second reference time, the processor 162 may stop rotating the fan 150.

According to the counted time reaching the second reference time while the processor 162 executes the operation mode and the cooling mode, the processor 162 may recognize a temperature detected by the temperature sensor 171 and humidity detected by the humidity sensor 172. Based on the recognized temperature being lower than the reference temperature and the recognized humidity being lower than the reference humidity, the processor 162 may stop rotating the fan, and, based on the recognized temperature being higher than or equal to the reference temperature or the recognized humidity being higher than or equal to the reference humidity, the processor 162 may continue to rotate the fan.

Stopping rotating the fan based on the recognized temperature and humidity may include terminating the cooling mode.

Continuing to rotate the fan based on the recognized temperature and humidity may include continuing to execute the cooling mode.

While the processor 162 maintains the cooling mode, the processor 162 may again recognize a temperature detected by the temperature sensor 171 and humidity detected by the humidity sensor 172 and continue to rotate the fan 150 until the recognized temperature becomes lower than the reference temperature and the recognized humidity becomes lower than the reference humidity. According to the recognized temperature being lower than the reference temperature and the recognized humidity being lower than the reference humidity, the processor 162 may stop rotating the fan 150.

While the processor 162 executes the operation mode, the processor 162 may control at least one of the display 132a or the speaker 132b to output information on whether the fan 150 rotates by an operation of the home appliance.

While the processor 162 executes the operation mode, the processor 162 may recognize an operation termination time of the home appliance and rotate the fan 150 at the recognized operation termination time of the home appliance, and, based on a time elapsed from the operation termination time reaching the second reference time, the processor 162 may stop rotating the fan.

While the processor 162 executes the operation mode, the processor 162 may recognize whether the home appliance is a home appliance of which a door opens before an operation termination time, based on operation information of the home appliance, and according to the home appliance being recognized as a home appliance of which a door opens before an operation termination time, the processor 162 may rotate the fan based on a remaining time of the home appliance reaching the first reference time and stop rotating the fan based on a time elapsed from the operation termination time of the home appliance reaching the second reference time.

For example, the home appliance of which the door opens before the operation termination time may include a dishwasher and an electric oven.

According to the home appliance being recognized as a home appliance of which a door opens after an operation termination time, the processor 162 may rotate the fan at an operation termination time of the home appliance, and, based on a time elapsed from the operation termination time of the home appliance reaching the second reference time, the processor 162 may stop rotating the fan.

For example, the home appliance of which the door opens after the operation termination time may include a dryer and a washing machine.

Hereinafter, a configuration of the processor that controls the fan based on operation information of a home appliance while executing the non-operation mode will be described.

While the processor 162 executes the non-operation mode, the processor 162 may wake up the communicator 161 based on a second time interval and attempt to communicate with at least one home appliance through the communicator 161. Here, the second time interval may be a reference time interval.

The at least one home appliance may include an appliance selected by a user.

The at least one home appliance may be a home appliance placed in the same space as the cooking apparatus 1 or a home appliance placed within a preset distance from the cooking apparatus 1. The preset distance may be a distance at which at least one of heat or steam generated from the home appliance may reach the cooking apparatus 1. The preset distance may be information obtained and stored through a test.

The non-operation mode may be a mode in which food is not cooked through the coils of the coil portion 140 and power is not supplied to the fan 150, the coil portion 140, and the communicator 161 while minimum power required for recognizing a power-on command and switching to a standby mode is supplied to the user interface 130, the processor 162, and the memory 163.

The second time interval may be equal to or longer than the first time interval.

The processor 162 may recognize priorities of home appliances capable of communicating with the cooking apparatus based on information stored in the memory 163.

The processor 162 may set the second time interval based on the priorities of the home appliances capable of communicating with the cooking apparatus.

In a case where the home appliances capable of communicating with the cooking apparatus are a dishwasher, a dryer, and a washing machine, the dishwasher may have a highest priority and the washing machine may have a lowest priority.

In the case where the home appliances capable of communicating with the cooking apparatus are a dishwasher, a dryer, and a washing machine, the processor 162 may check total operation times for operation courses of the dishwasher and set the second time interval based on a shortest total operation time among the total operation times for the operation courses. Here, the second time interval may be a reference time interval.

In a case where the home appliances capable of communicating with the cooking apparatus are a washing machine and a dryer, the processor 162 may check total operation times for operation courses of the dryer while executing the standby mode and set the second time interval based on a shortest total operation time among the total operation times for the operation courses.

In a case where the home appliances capable of communicating with the cooking apparatus are a washing machine, the processor 162 may check total operation times for operation courses of the washing machine and set the second time interval based on a shortest total operation time among the total operation times for the operation courses.

The processor 162 may check total operation times for operation courses for the respective home appliances capable of communicating with the cooking apparatus while executing the standby mode, check a shortest total operation time among the total operation times, and set the second time interval based on the checked total operation time.

The processor 162 may set the second time interval based on a user input received through the input interface 131. For example, the second time interval may be a time between 40 minutes and 70 minutes.

The processor 162 may recognize home appliances having operation courses that need to be monitored from among the home appliances capable of communicating with the cooking apparatus and set the second time interval based on priorities of the recognized home appliances.

The processor 162 may attempt to communicate with at least one home appliance while executing the standby mode, and when no response signal is received, the processor 162 may terminate the standby mode and execute the non-operation mode. That is, when the processor 162 fails to recognize a home appliance capable of communicating with the cooking apparatus, the processor 162 may terminate the standby mode and execute the non-operation mode.

After the processor 162 attempts to communicate with at least one home appliance while executing the standby mode, the processor 162 may receive operation information from the at least one home appliance. In this case, the processor 162 may maintain the standby mode based on the received operation information. The processor 162 may maintain the standby mode until the cooling mode starts.

After the processor 162 attempts to communicate with at least one home appliance while executing the standby mode, the processor 162 may receive response signals from home appliances capable of communicating with the cooking apparatus. In this case, the processor 162 may recognize distances to the home appliances capable of communicating with the cooking apparatus based on received signal strengths of the received response signals and recognize a home appliance of which a recognized distance is within a preset distance among the home appliances capable of communicating with the cooking apparatus.

The processor 162 may recognize whether the recognized at least one home appliance is a home appliance that needs to be monitored based on identification information of the recognized at least home appliance while executing the standby mode, and according the recognized at least one home appliance being identified as a home appliance that needs to be monitored, the processor 162 may store the identification information of the recognized home appliance.

The home appliance that needs to be monitored may include a home appliance that generates at least one of heat or steam.

The processor 162 may request operation information from the at least one home appliance capable of communicating with the cooking apparatus while executing the standby mode, and according to operation information being received from the at least one home appliance, the processor 162 may rotate the fan 150 based on the received operation information.

The processor 162 may recognize an operation start time and a total operation time based on the received operation information while executing the standby mode, recognize a remaining time based on the recognized operation state time and total operation time, and rotate the fan 150 based on the recognized remaining time.

The processor 162 may recognize an operation course of the home appliance based on the received operation information while executing the standby mode, recognize whether the recognized operation course of the home appliance is an operation course that needs to be monitored, and recognize, according to the recognized operation course being recognized as an operation course that needs to be monitored, an operation start time and a total operation time based on the received operation information.

The operation course that needs to be monitored may include an operation course that generates heat and steam.

The processor 162 may request a remaining time from the at least one home appliance 10 while executing the standby mode, and according to the remaining time being received from the at least one home appliance 10, the processor 162 may rotate the fan 150 based on the received remaining time.

Based on the remaining time of the home appliance reaching the first reference time while the processor 162 executes the standby mode, the processor 162 may rotate the fan 150.

The processor 162 may recognize whether an operation of the home appliance has terminated based on the remaining time while executing the cooling mode, and based on the operation of the home appliance being recognized to have terminated, the processor 162 may count a time elapsed from a time at which the operation of the home appliance has terminated. Based on the counted time reaching the second reference time, the processor 162 may stop rotating the fan 150.

When the processor 162 receives operation termination information of the home appliance from the home appliance while executing the cooling mode, the processor 162 may count a time elapsed from a time at which the operation termination information is received, and based on the counted time reaching the second reference time, the processor 162 may stop rotating the fan 150.

After the processor 162 stops rotating the fan, the processor 162 may terminate the cooling mode and switch to the non-operation mode.

When the processor 162 receives operation information from another home appliance while executing the standby mode, the processor 162 may recognize an operation termination time at which an operation of the other home appliance terminates based on the received operation information, and extend the standby mode based on the recognized operation termination time of the other home appliance. In this case, the processor 162 may switch to the cooling mode twice while executing the standby mode.

In a case where the home appliance that has transmitted the operation information is a dishwasher and a dryer, and the dryer terminates an operation after the dishwasher first terminates an operation, the processor 162 may rotate the fan 150 based on a remaining time of the dishwasher reaching the first reference time, and, when a time elapsed from a time at which the operation of the dishwasher has terminated reaches the second reference time, the processor 162 may stop rotating the first fan 150 and maintain the standby mode. Based on a remaining time of the dryer reaching the first reference time while the standby mode is maintained, the processor 162 may rotate the fan 150, and according to a time elapsed from a time at which the operation of the dryer has terminated reaching the second reference time, the processor 162 may stop rotating the fan 150.

Based on a counted time reaching the second reference time while the processor 162 executes the cooling mode, the processor 162 may recognize a temperature detected by the temperature sensor 171 and humidity detected by the humidity sensor 172. Based on the recognized temperature being lower than the reference temperature and the recognized humidity being lower than the reference humidity, the processor 162 may stop rotating the fan, and based on the recognized temperature being higher than the reference temperature or the recognized humidity being higher than the reference humidity, the processor 162 may continue to rotate the fan.

Stopping rotating the fan may include terminating the cooling mode.

Continuing to rotate the fan may include maintaining the cooling mode.

The processor 162 may again recognize a temperature detected by the temperature sensor 171 and humidity detected by the humidity sensor 172 while maintaining the cooling mode, continue to rotate the fan 150 until the recognized temperature becomes lower than the reference temperature and the recognized humidity becomes lower than the reference humidity, and when the recognized temperature becomes lower than the reference temperature and the recognized humidity becomes lower than the reference humidity, the processor 162 may stop rotating the fan 150.

The processor 162 may recognize an operation termination time of the home appliance while executing the non-operation mode and rotate the fan 150 at the recognized operation termination time of the home appliance, and based on a time elapsed from the operation termination time reaching the second reference time, the processor 162 may stop rotating the fan.

While the processor 162 executes the non-operation mode, the processor 162 may recognize whether the home appliance is a home appliance of which a door opens before an operation termination time, based on operation information of the home appliance. According to the home appliance being recognized as a home appliance of which a door opens before an operation termination time, the processor 162 may rotate the fan based on a remaining time of the home appliance reaching the first reference time, and based on a time elapsed from the operation termination time of the home appliance reaching the second reference time, the processor 162 may stop rotating the fan.

While the processor 162 executes the non-operation mode, according to the home appliance being recognized as a home appliance of which a door opens after an operation termination time, the processor 162 may rotate the fan at an operation termination time of the home appliance, and based on a time elapsed from the operation termination time of the home appliance reaching the second reference time, the processor 162 may stop rotating the fan. While the processor 162 executes the cooling mode, the processor 162 may control at least one of the display 132a or the speaker 132b to output information on whether the fan 150 rotates according to an operation of the home appliance.

The information on whether the fan 150 rotates may include information on the cooling mode.

When the processor 162 attempts to communicate with a home appliance, the processor 162 may perform switching from the non-operation mode to the standby mode and monitor the home appliance while executing the standby mode.

The standby mode may be a mode of supplying power required to operate the communicator 161, the processor 162, and the memory 163 to the communicator 161, the processor 162, and the memory 163.

The processor 162 may communicate with another home appliance while executing the standby mode.

The processor 162 may attempt to communicate with the other home appliance in real time or at the first time interval while executing the standby mode.

The processor 162 may attempt to communicate with the other home appliance at the second time interval while executing the standby mode.

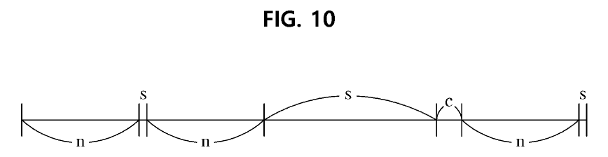

As shown in FIG. 10, the processor 162 may control switching from the operation mode n to the standby mode s at the second time interval and attempt to communicate with home appliances while executing the standby mode to recognize a home appliance capable of communicating with the cooking apparatus. When the processor 162 fails to recognize a home appliance capable of communicating with the cooking apparatus, the processor 162 may switch to the non-operation mode, and when the processor 162 recognizes a home appliance capable of communicating with the cooking apparatus, the processor 162 may maintain the standby mode.

The processor 162 may switch to the cooling mode based on a remaining time of the home appliance while executing the standby mode, switch to the non-operation mode based on termination of the cooling mode, recognize the second time interval by counting a time elapsed from a time at which switching to the non-operation mode has occurred, and switch to the standby mode s based on the counted time reaching the second time interval.

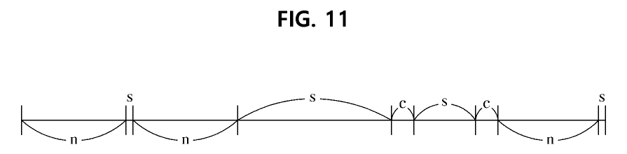

As shown in FIG. 11, when the processor 162 receives operation information from another home appliance while executing the standby mode, the processor 162 may recognize a termination time of the other home appliance based on the received operation information, extend an execution time of the standby mode s based on the recognized termination time of the other home appliance, switch to the cooling mode based on a remaining time of the other home appliance, switch to the standby mode s based on termination of the cooling mode for the other home appliance, switch to the cooling mode c based on the remaining time of the other home appliance, switch to the non-operation mode n based on termination of the cooling mode for the other home appliance, recognize the second time interval by counting a time elapsed from a time at which switching to the non-operation mode has occurred, and switch to the standby mode s based on the counted time reaching the second time interval.

The processor 162 may perform the above-described operations by using data stored in the memory.

The processor 162 may include hardware such as CPU or memory and software such as a control program. For example, the processor 162 may include at least one memory that stores data in a form of an algorithm or program for controlling operations of components in the cooking apparatus, and one, two, or more processor chips or one, two, or more processing cores that perform the above-described operations by using the data stored in the at least one memory. The processor 162 may be a single or a plurality of processors. The processor 162 may individually or collectively execute a control program to control the cooking apparatus 1.

The processor 162 may process various data and various signals by using instructions, data, programs, and/or software stored in the memory 163.

The processor 162 may generate a control signal for controlling a component of the cooking apparatus 1.

The processor 162 may include a separate neural processing unit (NPU) that performs operations of an artificial intelligence model, and may include a graphic processing unit (GPU), etc.

The memory 163 may store information on the first and second reference times and information on the reference temperature and reference humidity.

The memory 163 may store identification information of each home appliance and information on operation courses for each home appliance.

The information on the operation courses for each home appliance may include information on a total operation time for each operation course.

The memory 163 may store distance information corresponding to a received signal strength.

The memory 163 may store information on the first and second time intervals and information on the preset time and the preset distance.

The memory 163 may store information on priorities of a plurality of home appliances and information on operation courses for each home appliance.

The memory 163 may store information on a total operation time of each operation course for each home appliance.

The memory 163 may store data on an algorithm for controlling operations of components within the cooking apparatus or a program that reproduces the algorithm. In this case, the memory and processor may be implemented as separate chips. Alternatively, the memory and processor may be implemented as a single chip.

The memory 163 may be implemented as at least one of a non-volatile memory device, such as a cache, Read Only Memory (ROM), Programmable ROM (PROM), Erasable Programmable ROM (EPROM), Electrically Erasable Programmable ROM (EEPROM), and flash memory, a volatile memory device, such as Random Access Memory (RAM), or a storage medium, such as Hard Disk Drive (HDD) and Compact Disc Read Only Memory (CD-ROM), although not limited thereto.

The memory 163 may include one, two, or more memory chips or one, two, or more memory blocks.

At least one component may be added or omitted to correspond to performance of components of the cooking apparatus shown in FIG. 9. Also, it will be understood by one of ordinary skill in the art that mutual positions of the components may change to correspond to the performance and structure of the cooking apparatus.

The components shown in FIG. 9 may be software components and/or hardware components, such as a Field Programmable Gate Array (FPGA) and an Application Specific Integrated Circuit (ASIC).

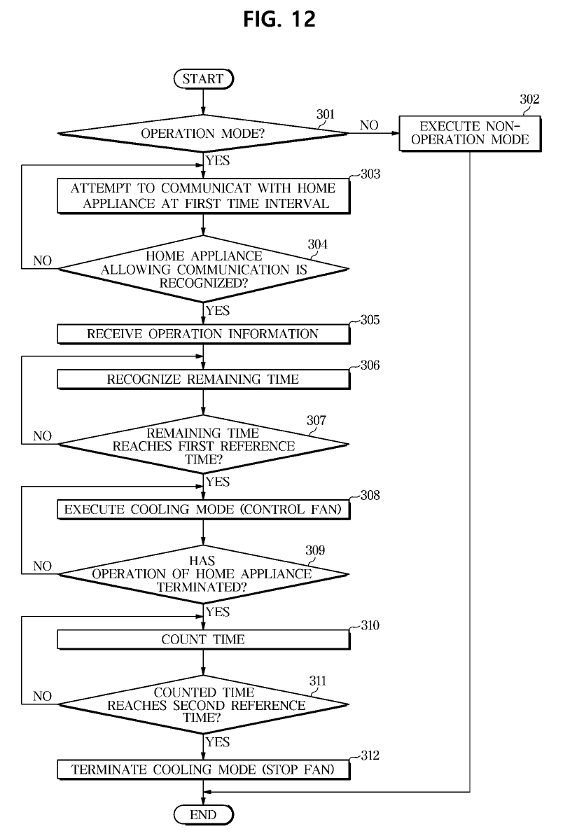

FIG. 12 is a control flowchart of an operation mode of a cooking apparatus according to an embodiment.

The cooking apparatus may identify whether a current mode is the operation mode (301). Based on the current mode not being identified as the operating mode, the cooking apparatus may execute a non-operation mode (302).

The operation mode may be a mode in which food is cooked through at least one coil provided in the cooking apparatus and power is supplied to the user interface, the at least one coil, the fan, the communicator, the processor, and the memory.

The non-operation mode may be a mode in which food is not cooked through any coil provided in the cooking apparatus and minimum power required for recognizing reception of a power-on command and a second time interval is supplied to the user interface 130, the processor 162, and the memory 163.

Based on the current mode being identified as the operation mode, the cooking apparatus may attempt to communicate with home appliances at a first time interval (303).

Based on the current mode being identified as the operation mode, the cooking apparatus may attempt to communicate with the home appliances in real time.

When the cooking apparatus receives a response signal from at least one home appliance after the cooking apparatus attempts to communicate, the cooking apparatus may recognize that communication with the home appliance that has transmitted the response signal is allowed.

When the cooking apparatus fails to receive a response signal from at least one home appliance after the cooking apparatus attempts to communicate, the cooking apparatus may recognize that there is no home appliance capable of communicating with the cooking apparatus.

The at least one home appliance 10 may include an appliance located within a preset distance from the cooking apparatus 1 or an appliance selected by a user.

Based on recognition of home appliances capable of communicating with the cooking apparatus (304), the cooking apparatus may receive operation information from the home appliances capable of communicating with the cooking apparatus (305).

The cooking apparatus may recognize distances to the home appliances 10 capable of communicating with the cooking apparatus based on received signal strengths of response signals received from the home appliances 10, recognize a home appliance of which a recognized distance is within the preset distance from among the home appliances capable of communicating with the cooking apparatus, and receive operation information from the recognized home appliance.

The recognized home appliance 10 may be a home appliance which is positioned adjacent to the cooking apparatus 1 in the same space as the cooking apparatus 1 and needs to be monitored for cooling control of the cooking apparatus. Hereinafter, a case in which one home appliance is recognized will be described as an example.

The cooking apparatus may request operation information from the recognized home appliance 10. Then, the cooking apparatus may receive operation information from the at least one home appliance 10.

The cooking apparatus may recognize an operation start time and a total operation time of the home appliance based on the received operation information and recognize a remaining time of the home appliance based on the recognized operation start time and total operation time of the home appliance (306).

The cooking apparatus may recognize an operation course of the home appliance based on the received operation information of the home appliance, recognize whether the recognized operation course of the home appliance is an operation course that needs to be monitored, and according to the recognized operation course of the home appliance being recognized as an operation course that needs to be monitored, the cooking apparatus may recognize an operation start time and a total operation time based on the received operation information.

The operation course that needs to be monitored may include an operation course that generates at least one of heat or steam.

The cooking apparatus may request a remaining time from the recognized home appliance 10. In this case, the cooking apparatus may receive the remaining time from the recognized home appliance 10.

Based on the remaining time of the recognized home appliance reaching the first reference time (307), the cooking apparatus may execute a cooling mode (308). Executing the cooling mode may include rotating the fan 150 to lower a temperature of the cooking apparatus and discharge steam to the outside.

The cooking apparatus may recognize an operation termination time of the home appliance based on the remaining time of the home appliance and terminate the cooling mode based on the recognized operation termination time and the second reference time. That is, the cooking apparatus may recognize operation termination of the home appliance based on the current time reaching the operation termination time (309), count a time elapsed from the operation termination time (310), and terminate the cooling mode based on the counted time reaching the second reference time (311 and 312).

Terminating the cooling mode may include stopping rotating the fan.

When the cooking apparatus receives operation termination information of the home appliance from the home appliance while executing the cooling mode, the cooking apparatus may count a time elapsed from a time at which the operation termination information is received and terminate the cooling mode based on the counted time reaching the second reference time.

Based on the counted time reaching the second reference time, the cooking apparatus may recognize a temperature detected by the temperature sensor 171 and humidity detected by the humidity sensor 172. Based on the recognized temperature being lower than the reference temperature and the recognized humidity being lower than the reference humidity, the cooking apparatus may terminate the cooling mode, and, based on the recognized temperature being higher than the reference temperature or the recognized humidity being higher than the reference humidity, the cooking apparatus may maintain the cooling mode.

The cooking apparatus may again recognize a temperature detected by the temperature sensor 171 and humidity detected by the humidity sensor 172 while maintaining the cooling mode, and according to the recognized temperature being lower than the reference temperature and the recognized humidity being lower than the reference humidity, the cooking apparatus may terminate the cooling mode.

The cooking apparatus may control at least one of the display 132a or the speaker 132b to output information on whether the fan 150 rotates according to an operation of the home appliance.

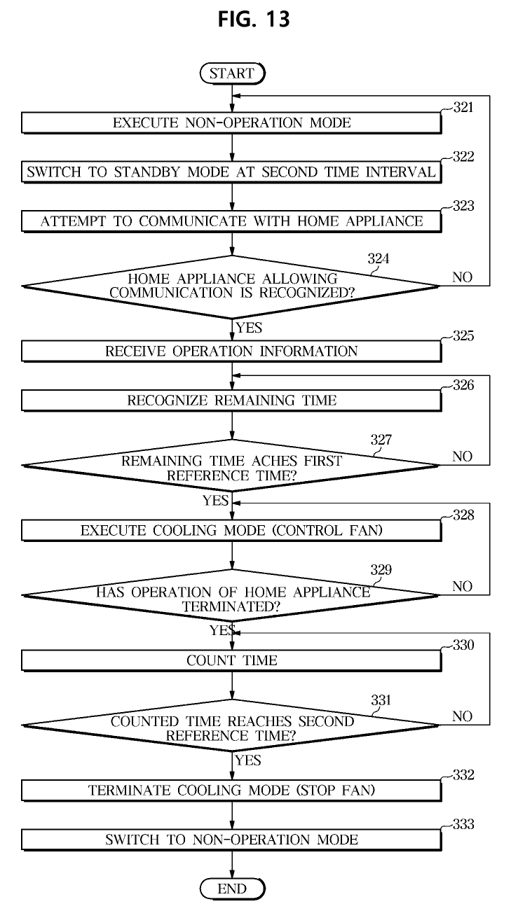

FIG. 13 is a control flowchart of a non-operation mode of a cooking apparatus according to an embodiment.

The cooking apparatus may execute the non-operation mode (321) and wake up the communicator 161 based on a second time interval while executing the non-operation mode to switch to a standby mode (322).

The cooking apparatus may attempt to communicate with at least one home appliance through the communicator 161 while executing the standby mode (323).

The at least one home appliance may include an appliance selected by a user, a home appliance located within a preset distance from the cooking apparatus, and a home appliance having an operation course that needs to be monitored.

The home appliance that needs to be monitored may include a home appliance that generates at least one of heat or steam.

The second time interval may be equal to or longer than the first time interval.

The second time interval may be information set by total operation times of operation courses of home appliances capable of communicating with the cooking apparatus.

The second time interval may be information set by a user input received through the input interface 131. For example, the second time interval may be a time between 40 minutes and 70 minutes.

The processor 162 of the cooking apparatus may recognize home appliances having operation courses that need to be monitored from among the home appliances capable of communicating with the cooking apparatus, and set the second time interval based on priorities of the recognized home appliances.

Based on a response signal being received from at least one home appliance, the cooking apparatus may recognize that there is a home appliance capable of communicating with the cooking apparatus, and when the cooking apparatus receives no response signal, the cooking apparatus may recognize that there is no home appliance capable of communicating with the cooking apparatus.

According to the cooking apparatus recognizing home appliances capable of communicating with the cooking apparatus (324), the cooking apparatus may receive operation information from the home appliances capable of communicating with the cooking apparatus (325).

The cooking apparatus may recognize distances to the home appliances 10 capable of communicating with the cooking apparatus based on received signal strengths of response signals received from the home appliances capable of communicating with the cooking apparatus, recognize a home appliance of which a recognized distance is within a preset distance from among the home appliances capable of communicating with the cooking apparatus, and receive operation information from the recognized home appliance. A case in which one home appliance is recognized will be described as an example.

The cooking apparatus may request operation information from the recognized home appliance 10. Then, the cooking apparatus may receive operation information from the at least one home appliance 10.

The cooking apparatus may recognize an operation start time and a total operation time of the home appliance based on the received operation information and recognize a remaining time of the home appliance based on the operation start time and total operation time of the recognized home appliance (326).

The cooking apparatus may recognize an operation course of the home appliance based on the received operation information of the home appliance and recognize whether the recognized operation course of the home appliance is an operation course that needs to be monitored, and, according to the recognized operation course of the home appliance being an operation course that needs to be monitored, the cooking apparatus may recognize an operation start time and a total operation time based on the received operation information.

The operation course that needs to be monitored may include an operation course that generates at least one of heat or steam.

The cooking apparatus may request a remaining time from the recognized home appliance 10. In this case, the cooking apparatus may receive a remaining time from the recognized home appliance 10.

Based on the recognized remaining time of the home appliance reaching a first reference time (327), the cooking apparatus may execute a cooling mode (328). Executing the cooling mode may include rotating the fan 150 to lower a temperature of the cooking apparatus and discharge steam to the outside.

The cooking apparatus may recognize an operation termination time of the home appliance based on the remaining time of the home appliance and terminate the cooling mode based on the recognized operation termination time and a second reference time. That is, based on a current time reaching the operation termination time, the cooking apparatus may recognize operation termination of the home appliance (329) and count a time elapsed from the operation termination time (330), and based on the counted time reaching the second reference time (331), the cooking apparatus may terminate the cooling mode (332) and switch to the non-operation mode (333).

Terminating the cooling mode may include stopping rotating the fan.

When the cooking apparatus receives operation termination information of the home appliance from the home appliance while executing the cooling mode, the cooking apparatus may count a time elapsed from a time at which the operation termination information is received and terminate the cooling mode based on the counted time reaching the second reference time.

Based on the counted time reaching the second reference time, the cooking apparatus may recognize a temperature detected by the temperature sensor 171 and humidity detected by the humidity sensor 172. Based on the recognized temperature being lower than a reference temperature and the recognized humidity being lower than reference humidity, the cooking apparatus may terminate the cooling mode, and based on the recognized temperature being higher than the reference temperature or the recognized humidity being higher than the reference humidity, the cooking apparatus may maintain the cooling mode.

While the cooking apparatus maintains the cooling mode, the cooking apparatus may again recognize a temperature detected by the temperature sensor 171 and humidity detected by the humidity sensor 172, and based on the recognized temperature being lower than the reference temperature and the recognized humidity being lower than the reference humidity, the cooking apparatus may terminate the cooling mode.

The cooking apparatus may control at least one of the display 132a or the speaker 132b to output information on whether the fan 150 rotates according to an operation of the home appliance.

The disclosed embodiments may be implemented in the form of a recording medium that stores instructions executable by a computer. The instructions may be stored in the form of program codes, and when executed by a processor, the instructions may create a program module to perform operations of the disclosed embodiments.

The machine-readable storage medium may be provided in the form of a non-transitory storage medium, wherein the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium. For example, the ‘non-transitory storage medium’ may include a buffer in which data is temporarily stored.

According to an embodiment of the disclosure, a method according to one or more embodiments disclosed in this document may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play StoreTM) or between two user devices (e.g., smart phones) directly. When distributed online, at least part of the computer program product (e.g., a downloadable app) may be temporarily generated or at least temporarily stored in the machine-readable storage medium, such as a memory of the manufacturer’s server, a server of the application store, or a relay server.

So far, the disclosed embodiments have been described with reference to the accompanying drawings. It will be apparent that those skilled in the art can make various modifications thereto without changing the technical spirit and essential features of the present disclosure. Thus, it should be understood that the embodiments described above are merely for illustrative purposes and not for limitation purposes in all aspects.

What is claimed is:

1. A cooking apparatus comprising:
a main body;
a communicator inside the main body;
a coil inside the main body, wherein the coil is configured to have a container placed above the coil;
a fan inside the main body;
memory storing at least one instruction; and
at least one processor,
wherein the at least one instruction, when executed by the at least one processor individually or collectively, causes the cooking apparatus to:
based on execution of an operation mode, supply power to the coil,
based on execution of a non-operation mode, block power from being supplied to the coil,
based on execution of the non-operation mode, execute a standby mode,
communicate with a home appliance using the communicator at a reference time interval while executing the standby mode, and
cause the fan to rotate based on operation information received from the home appliance.

2. The cooking apparatus of claim 1, wherein the at least one instruction, when executed by the at least one processor individually or collectively, further causes the cooking apparatus to:
recognize a remaining time until an operation termination time of the home appliance based on the received operation information,
based on the recognized remaining time reaching a first reference time, cause the fan to rotate, and
based on a time elapsed from the operation termination time of the home appliance reaching a second reference time, cause the fan to stop rotating.

3. The cooking apparatus of claim 1, wherein the at least one instruction, when executed by the at least one processor individually or collectively, further causes the cooking apparatus to:
maintain the standby mode based on the received operation information, and
based on failing to recognize a home appliance capable of communicating with the communicator while executing the standby mode, terminate the standby mode.

4. The cooking apparatus of claim 1, wherein the at least one instruction, when executed by the at least one processor individually or collectively, further causes the cooking apparatus to:
set the reference time interval for executing the standby mode based on a total operation time for an operation course of the home appliance.

5. The cooking apparatus of claim 1, wherein the memory stores information on priorities of a plurality of home appliances comprising the home appliance, and
wherein the at least one instruction, when executed by the at least one processor individually or collectively, further causes the cooking apparatus to:
recognize home appliances capable of communicating with the communicator,
recognize a home appliance having a highest priority from among the recognized home appliances based on the information on priorities, and
set the reference time interval based on an operation course of the home appliance having the highest priority.

6. The cooking apparatus of claim 1, further comprising an input interface configured to receive a user input,
wherein the at least one instruction, when executed by the at least one processor individually or collectively, further causes the cooking apparatus to set the reference time interval based on the user input received by the input interface.

7. The cooking apparatus of claim 1, further comprising
a temperature sensor inside the main body and configured to detect an internal temperature of the main body,
wherein the at least one instruction, when executed by the at least one processor individually or collectively, further causes the cooking apparatus to, based on the internal temperature detected by the temperature sensor while the fan rotates being lower than a reference temperature, cause the fan to stop rotating.

8. The cooking apparatus of claim 1, further comprising:
a humidity sensor inside the main body and configured to detect an internal humidity of the main body,
wherein the at least one instruction, when executed by the at least one processor individually or collectively, further causes the cooking apparatus to, based on the internal humidity detected by the humidity sensor while the fan rotates being lower than a reference humidity, cause the fan to stop rotating.

9. The cooking apparatus of claim 1, wherein the at least one instruction, when executed by the at least one processor individually or collectively, further causes the cooking apparatus to, based on operation information being received from another home appliance while executing the standby mode, extend an execution time of the standby mode and cause the fan to rotate based on the operation information received from the other home appliance.

10. The cooking apparatus of claim 1, wherein the at least one instruction, when executed by the at least one processor individually or collectively, further causes the cooking apparatus to:
based on execution of the operation mode, control the communicator to communicate with the home appliance in real time, and
cause the fan to rotate based on the received operation information.

11. The cooking apparatus of claim 1, wherein the at least one instruction, when executed by the at least one processor individually or collectively, further causes the cooking apparatus to:
based on execution of the operation mode, control the communicator to communicate with the home appliance at a first time interval, and
cause the fan to rotate based on the received operation information, and
wherein the first time interval is shorter than the reference time interval.

12. The cooking apparatus of claim 1, further comprising:
a temperature sensor inside the main body, wherein the temperature sensor is configured to detect an internal temperature of the main body; and
a humidity sensor inside the main body, wherein the humidity sensor is configured to detect an internal humidity of the main body,
wherein the at least one instruction, when executed by the at least one processor individually or collectively, further causes the cooking apparatus to, while executing the operation mode:
cause the fan to rotate based on the internal temperature detected by the temperature sensor exceeding a reference temperature or the internal humidity detected by the humidity sensor exceeding a reference humidity.

13. A method of controlling a cooking apparatus, the method comprising:
based on execution of a non-operation mode by the cooking apparatus, blocking power form being supplied to a coil of the cooking apparatus;
based on the execution of the non-operation mode by the cooking apparatus, executing a standby mode;
communicating with a home appliance at a reference time interval while executing the standby mode; and
causing a fan of the cooking apparatus to rotate based on operation information received from the home appliance.

14. The method of claim 13, wherein the causing the fan to rotate comprises:
recognizing a remaining time until an operation termination time of the home appliance based on the received operation information;
based on the recognized remaining time reaching a first reference time, causing the fan to rotate; and
based on a time elapsed from the operation termination time of the home appliance reaching a second reference time, causing the fan to stop rotating.

15. The method of claim 13, further comprising:
based on failing to recognize a home appliance capable of communicating with the cooking apparatus while executing the standby mode, terminating the standby mode; and
maintaining the standby mode based on the received operation information.
